(19) United States
(12) Patent Application Publication
(10) Pub. No.: US 2026/0239096 A1
(43) Pub. Date: Aug. 13, 2026

(54) METHODS RELATED TO RESUMING A RADIO CONNECTION FOR UE SUPPORTING EXTENDED REALITY AND MEDIA SERVICES

(71) Applicant: Google LLC, MOUNTAIN VIEW, CA (US)

(72) Inventor: Ching-Yu LIAO, Mountain View, CA (US)

(21) Appl. No.: 19/157,056

(22) PCT Filed: Feb. 19, 2024
(86) PCT No.: PCT/US2024/016391

§ 371 Date: Aug. 15, 2025

Related U.S. Application Data
(60) Provisional application No. 63/446,889, filed on Feb. 19, 2023.
(60) Provisional application No. 63/541,537, filed on Sep. 29, 2023.

(51) Int. Cl. H04W 28/02

(52) U.S. Cl. CPC H04W 28/0268

(57) ABSTRACT

Methods and devices in a wireless network wireless communication are directed to informing core network functions about a radio access network node's ability to provide extended reality and media services in a connection resume procedure context. A radio access network node serving a user equipment transmits, to a core network node, its extended reality and media service capability for packet data unit set based quality of service handling when the user equipment resumes an RRC_connected state. The user equipment then receives a packet data unit set based quality of service traffic for providing an XRM service to the user equipment.

### FIELD OF THE DISCLOSURE

This document describes methods and devices operating in wireless communication systems such as (but not limited to) the ones described 3^{rd} Generation Partnership Project (3GPP) technical specifications, known as fifth generation (5G) communication systems. More particularly, some embodiments are related to resuming a radio connection between a user equipment (UE) and a network entity (NE) such as a base station (BS) in the wireless communication system, when a packet data unit (PDU) session for providing extended reality and media (XRM) services to a user equipment (UE) exists prior to the UE becoming inactive.

### BACKGROUND

This background description is provided for the purpose of generally presenting the technical context and problems. Work of the presently named inventors, to the extent it is described in this background section, as well as described aspects that may not otherwise qualify as prior art at the time of filing, are neither expressly nor impliedly admitted as prior art against the present disclosure.

A next generation radio access network (NG-RAN) node in a 5^{th} generation (5G) system might be configured to support extended reality and media (XRM) services handling packet data unit (PDU) Sets based on PDU Set quality of service (QOS). The NG-RAN node's XRM service capability indicates whether a specific NG-RAN node is able to support XRM services handling PDU Sets based on PDU Set QoS. The NG-RAN node may be unable to provide such XRM services to a user equipment (UE) (at least not at a particular time or not at all time).

When a UE transitions from a radio resource control (RRC) inactive state to an RRC_connected state, the 5G core network (CN) may not know whether the NG-RAN node serving the UE is currently able to support XRM services by handling PDU sets based on QoS. While the UE was in the RRC_inactive state, an NG-RAN's XRM service capability for serving the UE may have changed. Such a change may be due to a change of the serving NG-RAN node or a change of the NG-RAN's node XRM service capability (e.g., due to the traffic volume).

Another related problem occurs when the NG-RAN may need assistance and/or information to determine whether and how to let a UE, supporting XRM services, enter an RRC inactive state and a CM-Connected state.

### SUMMARY

Various embodiments overcome the above-identified problems by using various techniques performed by the user equipment (UE), the next generation radio access network (NG-RAN) node, or a core network (CN) node hosting an Access and Mobility Management Function (AMF).

In some embodiments, the UE provides an XRM service indication to the currently-serving NG-RAN node, in a radio resource control (RRC) message (e.g., an RRCResume message or an RRCComplete message) when initiating a connection resume procedure. The UE may determine whether to include the XRM service indication in the RRC message based on UE context (i.e., when there is a change of the NG-RAN node and there is an active XRM PDU session) or based on a suspend configuration provided to the UE by the serving NG-RAN node when the UE entered an RRC inactive state. Upon receiving the XRM service indication, the currently-serving NG-RAN informs a CN node (e.g., the CN node hosting the AMF function) about its XRM service capabilities (SC) for PDU Set based handling (also called for the remainder of this document ‘XRM service capabilities (SC)’ for simplicity). The AMF then indicates the NG-RAN's XRM SC, to a session management function (SMF) that prompts a user plane function (UPF) to enable PDU Set based handling for a QoS flow for providing the XMR service with PDU Set based QoS to the UE.

In some embodiments, the NG-RAN notifies the CN node about its XRM capabilities for PDU Set based QoS handling when at least one of a set of conditions is met. One such condition is the UE initiating a connection resume procedure. Another condition is when a change of the NG-RAN node occurs while there is an active XRM PDU session with at least one PDU set based QoS flow.

A CN node hosting the AMF may provide, to the NG-RAN node, CN assistance information related to an RRC_inactive UE associated to the NG-RAN node.

The CN node hosting the AMF may additionally or alternatively request the NG-RAN node to provide its XRM service capabilities for PDU set based QoS handling along with an RRC_inactive state report or upon receiving a path switch-related message. The CN node hosting the AMF may also request the NG-RAN node to provide a notification when a UE RRC state transition occurs or when the UE initiates a connection resume procedure.

### BRIEF DESCRIPTION OF THE DRAWINGS

The accompanying drawings, which are incorporated in and constitute a part of the specification, illustrate one or more embodiments and, together with the description, explain these embodiments.

FIG. 1 is a is a block diagram of a wireless communication system in which a UE, an NG-RAN node, and a CN node perform methods according to various embodiments.

FIG. 2 is a signal diagram illustrating a scenario in which the NG-RAN provides its NG-RAN XRM service capability to a CN node hosting the AMF according to an embodiment.

FIG. 3 is a signal diagram illustrating a scenario similar to the scenario in FIG. 2 in which the currently-serving NG-RAN node retrieves NG-RAN context from the previously-serving NG-RAN node according to an embodiment.

FIG. 4 is a signal diagram illustrating a scenario in which a CN node acquires information of NG-RAN's XRM service capabilities via an N2 message according to an embodiment.

FIG. 5 is a signal diagram illustrating a scenario in which a UE provides an XRM service indication in an RRCResumeRequest message to its currently-serving NG-RAN node thereby triggering the NG-RAN node to convey its XRM service capability using a path switch request to the CN node according to an embodiment.

FIG. 6 is a signal diagram illustrating a scenario similar to the scenario illustrated in FIG. 5, but here the UE provides an XRM service indication in an RRCResumeComplete message according to an embodiment.

FIG. 7 is a signal diagram illustrating a scenario similar to the scenario illustrated in FIG. 5, but in which the UE provides its XRM service indication in an RRCResumeRequest message based on a suspend configuration the UE received from its last-serving NG-RAN node before the UE became inactive according to an embodiment.

FIG. 8 is a signal diagram illustrating a scenario similar to the scenario illustrated in FIG. 7, but here the UE provides an XRM service indication in an RRCResumeComplete message according to an embodiment.

FIG. 9 is a signal diagram illustrating a scenario similar to the scenario illustrated in FIG. 4, but in which a currently serving NG-RAN node determines whether to signal its XRM service capability to the CN node hosting the AMF according to an embodiment.

FIG. 10 is a signal diagram illustrating a scenario in which the SMF subscribes for NG-RAN XRM service capability notification and the AMF requests RRC state transition notification based on the AMF UE context according to an embodiment.

FIG. 11 is a signal diagram illustrating a scenario similar to the scenario illustrated in FIG. 10, but with a change of the serving NG-RAN while the UE is in an RRC_Inactive state according to an embodiment.

FIG. 12 is a signal diagram illustrating a scenario in which the AMF and/or an SMF requests the NG-RAN's XRM service capabilities upon receiving an RRC state transition notification according to an embodiment.

FIG. 13 is a flowchart of a method performed by a CN element in a resume connection procedure context according to an embodiment.

FIG. 14 is a flowchart of a method performed by an NG-RAN node in a resume connection procedure context according to an embodiment.

FIG. 15 is a flowchart of a method performed by a UE in a resume connection procedure context according to an embodiment.

### DETAILED DESCRIPTION

Methods and devices described in this section embody techniques related to a user equipment (UE) resuming its connection with a wireless communication system, with the UE having a packet data unit (PDU) session for extended reality and media (XRM) services established before the UE entered the inactive state. The embodiment descriptions in this section refer to the accompanying drawings. The same reference numbers in different drawings identify the same or similar elements. The detailed descriptions do not preclude other embodiments within the scope of the appended claims (for example, applying one or more methods to a radio access technology (RAT) other than 5G, e.g., 6G). The embodiments are not limited to the described configurations but may be extended to other arrangements.

Conventional next generation radio access networks (NG-RANs) deploy NG-RANs with and without XRM service capabilities that includes but it is not limited to PDU Set based handling. An NG-RAN that does not support XRM services is unable to support a PDU Set based quality of service (QOS) to the UE. While the NG-RAN node serving the UE before the UE becomes inactive was able to support XRM services, whether the NG-RAN node serving the UE transitioning to active state is able to support XRM services is not necessarily known. The UE switches from an RRC_connected state to an RRC_inactive state upon receiving, from the network, an RRC release with suspend configuration and resumes the RRC_connected state by paging the network with an RRC resume request. Unlike in the RRC_idle state, the NG-RAN node does not release the UE context for the UE in the RRC inactive state. Meanwhile, there are two connection management (CM) states reflecting a UE's non-access stratum (NAS) connection with the AMF: CM-idle and CM-connected. Unlike when in CM-idle state, a UE in a CM-connected state may exchange NAS messages with the AMF using an N1 interface (as defined in 3GPP technical specifications).

Providing an end-to-end (i.e., UE to PDU Session Anchor (PSA) UPF via the NG-RAN node) PDU set based QoS flow for the XRM services becomes uncertain when the UE resumes an active connection (i.e., RRC_connected state). The application function (AF) related to these XRM services may continue to request PDU Set based QoS requirements to the 5G core network (CN), and the 5G CN (e.g., Policy Control Function (PCF), Session Management Function (SMF), User Plane Function (UPF)) would then continue trying (though maybe it is not possible due to the current NG-RAN's XRM service capability) to manage PDU Set based QoS flows and enforce corresponding configurations for PDU Set based handling. This situation may cause unnecessary signaling overheads for PDU Set based handling thereby wasting energy and communication resources. Therefore, there is a need for techniques to make information regarding an NG-RAN's XRM services capabilities for PDU Set based handling of the currently serving NG-RAN node available to the fifth generation (5G) core network (CN) when the UE resumes its connection with the network (i.e., switches from RRC_inactive to RRC_connected state).

For example, in the downlink, the UPF may continue to perform deep packet inspection on PDUs in order to perform PDU Set identification and marking as well as enforcing QoS for the PDUs and the PDU Sets based on the instructions from the SMF. If the NG-RAN does not support the corresponding PDU Set QoS parameters (e.g., PDU Set Delay Budget (PSDB), PDU Set Error Rate (PSER)) for the QoS flow (also called PDU Set based QoS flow for the remainder of this document for simplicity), the NG-RAN becomes a broken link for managing end-to-end QoS for the QoS flows of the XRM services.

In another example, in the uplink, the UE may continue to perform PDU Set identification and marking for the PDUs from the XRM applications as well as enforce QoS flow binding for the PDUs and the PDU Sets based on the instructions from the SMF. If the NG-RAN does not support the corresponding PDU Set QoS parameters for the QOS flow, the NG-RAN becomes a broken link for managing end-to-end QoS for the QoS flows of the XRM services. As such, in both examples, the network experiences unnecessary signaling overheads for PDU set based handling and waste of energy and communication resources.

Some embodiments also relate to how a 5G CN handles PDU Sessions for UEs switching from/to an RRC-inactive state. Currently, the solutions for QoS provisioning of the XRM services only consider UEs in a CM connected state. However, there are open issues at least in the following scenarios.

In a first scenario, the NG-RAN may need assistance information to determine whether and how to let a UE enter an RRC-inactive state and CM-Connected state. Currently there is no technique for providing the assistance information from the CN to the NG-RAN (when there is a PDU Session) for providing, to the UE, XRM services using PDU Set based QOS flows.

In a second scenario, while the UE is in RRC-inactive and CM-Connected state, the NG-RAN's XRM service capabilities might change because, for example, the UE moves to a new NG-RAN that may or may not support XRM service capabilities for PDU Set based handling. When the UE resumes the connection and enters the RRC-connected state (due to having uplink packets or a ping message from the network for the XRM services or performing RAN based notification area (RNA) update), the CN is uncertain whether the new NG-RAN serving the UE supports XRM service that requires PDU Set based QoS. Therefore, there opportunities for mechanisms to determine whether or how to resume a connection taking into consideration a current NG-RAN's XRM services capabilities.

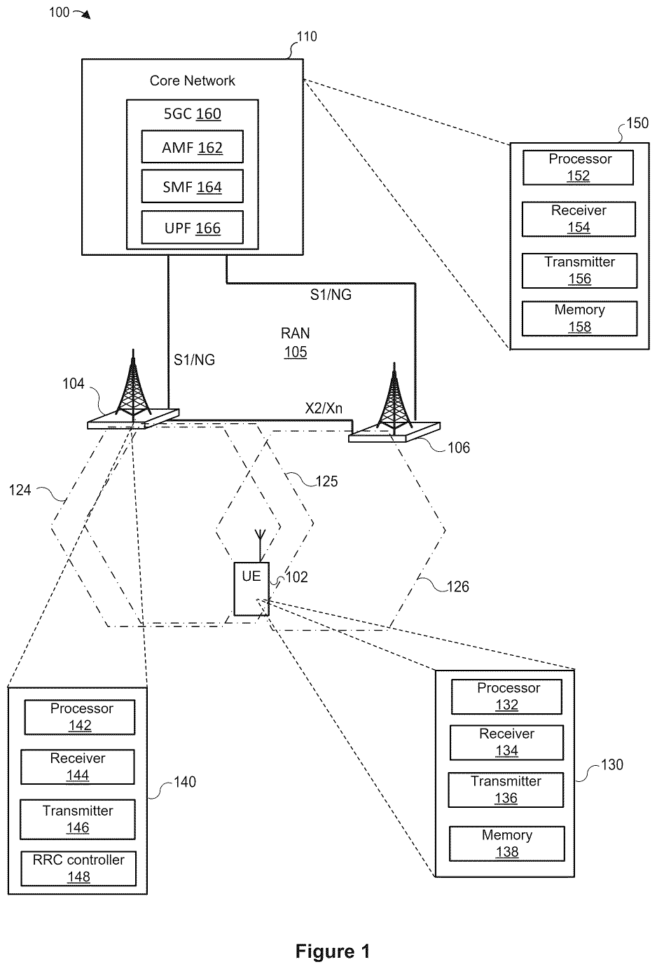

Before discussing various solutions to the problems noted above, a wireless communication system 100 in which a UE, a RAN node and a CN node may perform methods according to various embodiments is described using the block diagram in FIG. 1. The wireless communication system 100 includes a UE 102, a first RAN node 104, a second RAN node 106, and a CN 110. The RAN 105 connects RAN nodes 104 and 106 to the CN 110. For that sake of simplicity and clarity, the following description refers mostly to 5G radio access technology (RAT), but this RAT is an illustration and should not be interpreted as a limitation, other RATs such as a sixth generation (6G) RAT may be employed. Thus, the CN 110 is a 5G CN (5GC) 160, the RAN nodes 104 and 106 are NG-RAN nodes, and the RAN 105 is a 5G RAN.

FIG. 1 illustrates the first RAN node 104 as covering (i.e., intermediating communication with UEs located within) a first cell 124 and a second cell 125 and the second RAN node 106 covers a cell 126. These cells (i.e., 124, 125, and 126) are New Radio (NR) cells. The cells 124, 125, and 126 may be in the same Radio Access Network Notification Areas (RNA) or different RNAs. In general, the RAN 105 can include any number of RAN nodes, and each of the RAN node can cover one, two, three, or any other suitable number of cells. The UE 102 can support a 5G NR (or simply, “NR”) air interface to communicate with the RAN nodes 104 and/or 106. Each of the RAN nodes 104, 106 may connect to CN nodes (i.e., physical devices hosting CN functions) via a CN-based interface (e.g., an S1 or an Ng interface). The RAN nodes 104 and 106 may also be interconnected via other specific interfaces (e.g., X2 or Xn interface).

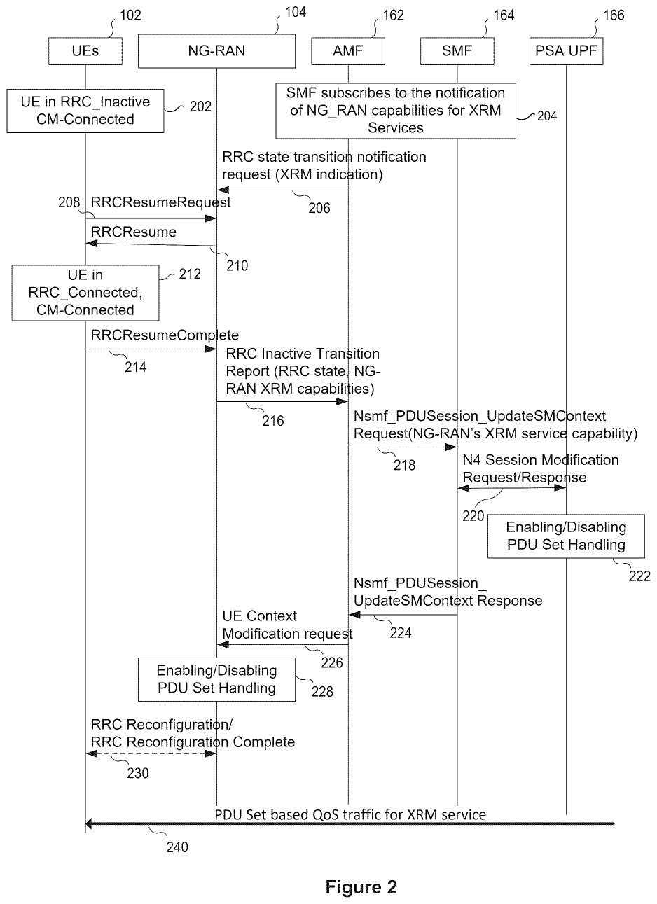

As illustrated in FIG. 1, the 5GC 160 includes an Access and Mobility Management Function (AMF) 162, a Session Management Function (SMF) 164 and a User Plane Function (UPF) 166 but 5G cores include other functions not illustrated in FIG. 1. Each of 5GC functions may be hosted by a CN node including processing hardware 150 that typically includes a processor 152, a transmitter 154, a receiver 156, and a memory 158 (which may store executable instructions for the processor to perform various methods described hereinafter). The same CN node may execute more than one CN function or instances of a CN function. The AMF 162 is configured to manage authentication, registration, paging, and other related functions, the SMF 164 is configured to manage PDU sessions, and the UPF 166 is configured to transfer user-plane packets related to audio calls, video calls, Internet traffic, etc. The CN 110 may have a plurality of UPFs instances running on the same CN node or on different CN devices. In order to pinpoint the UPF employed relative to the UE's PDU session in the signal diagrams illustrated in FIGS. 2-12, a specific UPF instance is indicated as the PDU Session Anchor (PSA) UPF 166.

The first RAN node 104 is equipped with processing hardware 140 that may include one or more general-purpose processors and/or special-purpose processing units. The processing hardware 140 illustrated in FIG. 1 includes a processor 142 configured to process data that the first RAN node 104 transmits in the downlink (DL) direction (i.e., to a UE), or receives in the uplink (UL) direction (i.e., from a UE). The processing hardware 140 also includes a transmitter 146 configured to transmit data in the DL direction and a receiver 144 configured to receive data in the UL direction (or, alternatively, a transceiver performing both transmitting and receiving data). The processing hardware 140 may also include a non-transitory computer-readable memory 148 storing instructions that the one or more processors execute. The second RAN node 106 can include generally similar components.

The UE 102 is equipped with processing hardware 130 that includes one or more general-purpose processors and/or special-purpose processing units. The processing hardware 130 illustrated in FIG. 1 includes a processor 132 to process UL data that the UE 102 transmits, and/or DL data the UE receives. The processing hardware 130 also includes a transmitter 136 configured to transmit UL data and a receiver 134 configured to receive DL data (or, alternatively, a transceiver performing both transmitting and receiving data). The processing hardware 130 may also include a non-transitory computer-readable memory 138 storing machine-readable instructions executable on the one or more general-purpose processors, and/or special-purpose processing units.

Embodiments described hereinafter may use the following assumptions:
(i) a PDU Set is made of one or more PDUs carrying the payload of one unit of information generated at the application level (e.g., a frame or video slice for XR Services); (ii) the NG-RAN might or might not support NG-RAN's XRM services capabilities for PDU Set based Handling; and (iii) the UE might or might not support UE's XRM services capabilities for PDU Set based Handling.

In the embodiments described in this section, the 5GC enables or disables PDU set based handling for a UE 102 subscribed to XRM services when the UE 102 resumes a connection, depending on a current NG-RAN's XRM service capabilities for PDU Set based handling.

In order to support XRM services, the AMF authorizes a UE during the UE's registration based on the UE's XRM service capability and the UE's subscription. When the SMF 164 subscribed for an event exposure notification, the AMF 162 may send, to the SMF 164, information on NG-RAN's XRM service capability (e.g., using an Namf_EventExposure_Notify message or an Nsmf_PDUSession_UpdateSMContextRequest message). Based on information on current NG-RAN's XRM service capabilities, the SMF 164 determines whether to configure PSA UPF for enabling or disabling the PDU Set based handling on PDU Set based QoS flow providing the XRM traffic to the UE 120.

In some situations, the AMF 162 provides core network assistance information (CNAI) for RRC inactive to the NG-RAN 104, to assist the NG-RAN 104 in deciding whether to switch the UE 102 in an inactive state. Such situations include at least one of the following: (1) the UE 102 is authorized for XRM services according to the UE context that the AMF 162 stores during the UE's registration; (2) the UE context includes PDU session information including at least one PDU Set based QoS flow related to XRM services; and/or (3) the SMF 164 or the policy and control function (PCF) has subscribed to be notified about NG-RAN's XRM service capability for PDU Set based handling.

The CNAI may indicate one or more of: (i) UE's support for XRM services; (ii) whether there is any active PDU session with PDU Set based QoS flow for providing XRM services to the UE; (iii) no inactive state being preferred due to active XRM services; and/or (iv) an extended discontinuous reception (eDRX) for a UE 102 with an active XRM PDU session.

In some embodiments, the AMF 162 or the SMF 164 requests an N2 notification about NG-RAN's XRM service capabilities when a UE 102 resumes the RRC connection (i.e., switches from RRC_inactive state to RRC_connected state). The AMF or the SMF may request such an N2 notification when: (1) the UE 102 is authorized for XRM services according to the UE context that the AMF 162 stores during UE's registration; (2) the UE context includes PDU session information with PDU Set based QoS flow related to XRM services; (3) the SMF 164 or PCF has subscribed to be notified about NG-RAN's XRM service capability for PDU handling; and/or (4) the SMF 164 stores PDU session information with XRM service indication.

Upon receiving notification about a UE's RRC state transition and serving NG-RAN's XRM service capabilities from the NG-RAN, the AMF 162 may indicate to the SMF/PCF to enable/disable PDU set based handling for the PDU Set based QoS flow of the UE's XRM service. The SMF 164 may have subscribed to be notified by the AMF 162 about this information (i.e., UE's RRC state transition and serving NG-RAN's XRM service capabilities). In one embodiment the AMF 162 may transparently forward NG-RAN's notification of this information. The SMF 164 may in advance request NG-RAN's XRM service capability directly via Namf_N2InfoSubscribe message to the NG-RAN via the AMF 162. In response, the NG-RAN 104 then sends the XRM service capabilities in Namf_N2InfoNotify message to the SMF 164 via AMF 162.

FIGS. 2-12 are signal diagrams illustrating messages exchanged in different scenarios between the UE 102, the NG-RAN node 104 and CN functions (such as AMF 162, SMF 164, and PSA UPF 166) hosted by at least one CN node.

Time flows from top to bottom, that is, events and messages illustrated lower occur later than the ones illustrated higher particularly when related to the same device/function. Some events or messages occur in multiple scenarios illustrated in FIGS. 2-12 so their description repetition is omitted; instead, the descriptions emphasize differences as appropriate. 3GPP technical specifications may include definition of messages and procedures similar to the ones illustrated in these figures, but the standard defined messages are modified as discussed to include XRM-related information. The NG-RAN node serving the UE 102 before the UE enters an RRC_inactive state may be a different from the NG-RAN node serving the UE when it resumes to the active state or may be the same NG-RAN with changed XRM service capabilities (e.g., XRM service capabilities in the same NG-RAN may change if conditions associated with the NG-RAN change, such as, an increase in traffic that would impact XRM service delivery). The same reference numbers may be used to label substantially similar messages or actions, and their description is then omitted.

FIG. 2 is a signal diagram illustrating a scenario in which the NG-RAN node 104 (which may at times be called “NG-RAN”) provides its NG-RAN XRM service capability for PDU Set based handling to a CN node hosting the AMF 162 according to an embodiment. In this scenario, the UE 102 is connected to the same NG-RAN 104 when resuming the active state as before entering the inactive state. Some messages in this signal diagram correspond to messages described in 3GPP technical specifications (for example, TS 23.502 and TS 38.300) which are modified as needed to support the AMF 162 to trigger disabling or enabling PDU Set based handling at the SMF/UPF based on the current NG-RAN's XRM services capabilities for PDU Set based handling.

The UE 102 is initially 202 in an RRC_Inactive CM-Connected state.

Meanwhile the SMF 164 subscribes 204 to the notification of NG-RAN's XRM service capabilities for PDU set based handling. The AMF 162 then sends 206 an RRC-state-transition-notification request to the NG-RAN 104. This request includes an XRM service indication.

In order to resume the connection with the network, the UE 102 transmits 208 an RRCResumeRequest message to the NG-RAN 104. The NG-RAN 104 responds 210 with an RRCResume message to the UE 102. Upon receiving the RRCResume message, the UE 102 enters 212 the RRC_Connected (and CM-Connected) state. To complete the resumption of the RRC connection, the UE 102 sends 214 an RRCResumeComplete message to the NG-RAN 104.

The serving NG-RAN 104 then sends 216, to the AMF 162, an RRC_Inactive_Transition_Report that indicates UE's RRC state and its NG-RAN XRM service capabilities for PDU Set based handling. The N2 network interface is used to exchange messages between the NG-RAN 104 and the CN functions such as the AMF 162. A CN node with processing hardware such as processing hardware 150 illustrated in FIG. 1 hosts (i.e., executes) the AMF 162 which may transfer N2 message to NG-RAN on behalf of other CN functions. The same CN node may host the other functions illustrated in the signal diagrams. Moreover, the CN node may host multiple instances of CN functions.

After receiving 216 the RRC_Inactive_Transition_Report, the AMF 162 sends 218 an Nsmf_PDUSession_UpdateSMContext_Request including the NG-RAN 104's XRM service capabilities to the SMF 164. Based on the NG-RAN 104's XRM service capabilities, the SMF 164 determines how to configure the PSA UPF 166 using 220 an N4 PDU session modification request/response procedure. The PSA UPF 166 may enable or disable 222 PDU set based handling as prompted by SMF 164 based on the NG-RAN 104's XRM capabilities. N4 is a network interface between the control plane and the user plane.

The SMF 166 then transmits 224, to the AMF 162, information regarding the PDU set based handling in an Nsmf_PDUSession_UpdateSMContext response message. In this embodiment, because the serving NG-RAN 104 does not change (i.e., serves the UE 102 both before entering the RRC_inactive state and after returning to RRC_connected state), the AMF 162 transmits 226 a UE Context Modification request to the NG-RAN 104. This request may include updated PDU Set QoS parameters for XRM services. Based on the information received in the UE Context Modification request, the NG-RAN 104 then enables/disables 228 PDU set based handling. The NG-RAN 104 and the UE 102 may then exchange 230 messages/information associated with an RRC connection reconfiguration procedure to reconfigure the UE 102 for radio resource management or for enabling/disabling PDU set based handling for XRM services.

While in an RRC_Inactive state (and CM-Connected state), the UE 102 initiates the RRC connection resume procedure (to move from an RRC_Inactive state to an RRC_Connected state) in the following situations: (1) UE's upper layers receive user plane packets for uplink transmission or responds to a received paging message related to user plane downlink traffic; and (2) UE's Access Stratum (AS) layer responds to RAN paging or triggers RNA (RAN Notification Areas) updates.

In order to initiate an RRC resume procedure, the UE 102 sends an RRC message to the NG-RAN 104. This RRC message is an RRCResumeRequest1 or RRCResumeRequest message including proper resume causes. The information element (IE) ResumeCause is used to indicate the resume cause in the RRCResumeRequest or RRCResumeRequest1.

Finally, the UE 102 receives 240 PDU Set based QoS traffic for the XRM service from a data network (not shown).

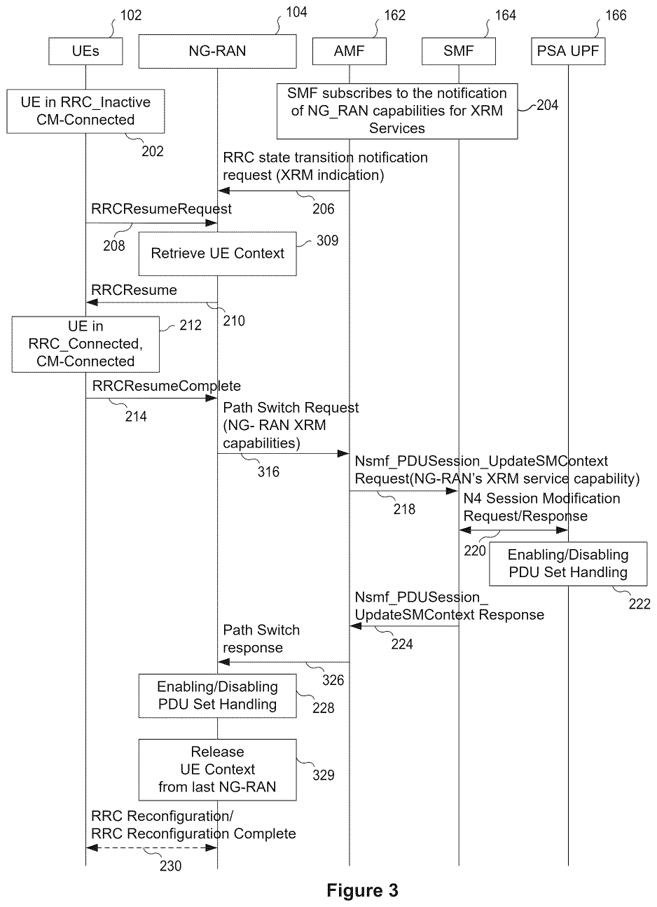

FIG. 3 is a signal diagram illustrating a scenario similar to the scenario in FIG. 2 in which the currently-serving NG-RAN node retrieves NG-RAN context from the previously-serving NG-RAN node according to an embodiment. Discussion of steps and actions in FIG. 3 that are substantially the same as in FIG. 2 is omitted.

The differences between the scenario in FIG. 2 and the scenario in FIG. 3 are now described. The currently serving NG-RAN 104 is different from the NG-RAN serving the UE 102 when the UE 102 entered the RRC_inactive state, therefore the NG-RAN 104 retrieves 309 the NG-RAN UE context information from the previous-serving NG-RAN, before sending 210 an RRCResume message to the UE 102. Because the UE-serving NG-RAN has changed while the UE was in the RRC_inactive state, the currently serving NG-RAN 104 sends 316 a Path Switch Request message indicating the RRC state of the UE 102 and the NG-RAN XRM capabilities for PDU Set based handling to the AMF 162.

After receiving 224 the Nsmf_PDUSession_UpdateSMContext response, the AMF 162 sends 326 a Path Switch response (e.g., a Path Switch Request Acknowledgement), which may include PDU set QoS parameters for XRM services information to the NG-RAN 104. Based on the information received in the Path Switch response, NG-RAN 104 enables/disables 228 PDU set based handling. Further, because the serving NG-RAN has changed, the NG-RAN 104 may trigger the release of the resources at the previously-serving NG-RAN (not shown). The NG-RAN 104 and the UE 102 may then exchange messages/information associated with an RRC Connection Reconfiguration/RRC Reconfiguration Complete 230 to reconfigure the UE 102 for radio resource management or for enabling/disabling PDU set based handling for XRM services. Finally, although not shown in this and future signal diagrams, the UE 102 receives 240 PDU Set based QoS downlink traffic for the XRM service from a data network and performs PDU Set based handling for PDU Set based QoS uplink traffic.

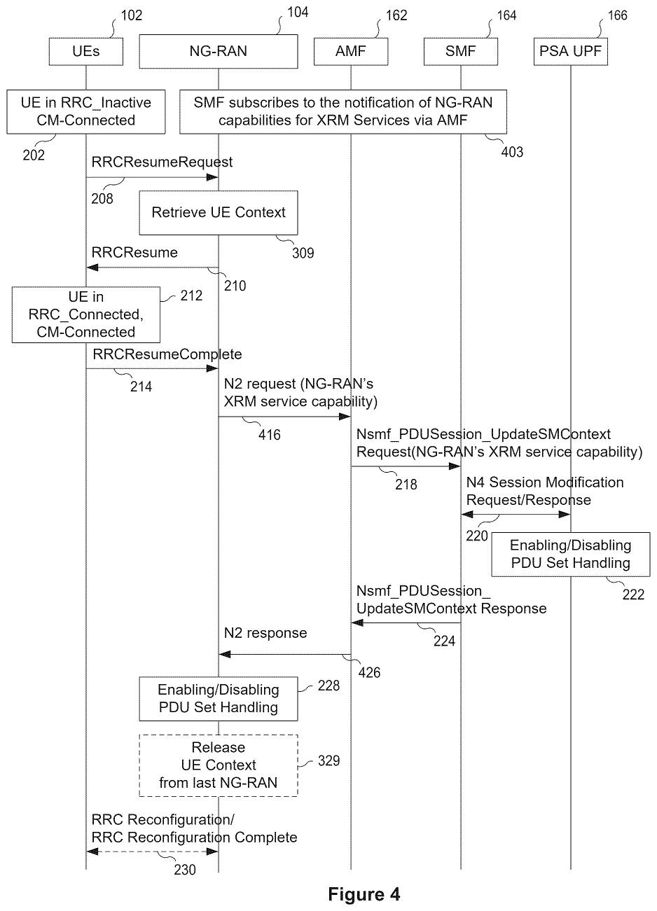

FIG. 4 is a signal diagram illustrating a scenario in which a CN node acquires information regarding an NG-RAN's XRM service capabilities via an N2 message according to an embodiment. The scenario illustrated in FIG. 4 is similar to the scenario illustrated in FIG. 3 with the differences discussed below. In FIG. 4, the SMF 164 subscribes 403 to the notification of NG-RAN's XRM service capabilities for PDU Set based handling via the AMF 162.

Later, the NG-RAN 104 sends 416 an N2 message including the NG-RAN's XRM serviced capabilities for PDU Set based handling to the AMF 162. For example, if there is no change of NG-RAN and the AMF 162 does not request RRC_Inactive state transition notification, the NG-RAN 104 resumes the RRC connection without notifying the AMF 162. In another example, if there is no change of NG-RAN and the serving NG-RAN needs to change its support of the NG-RAN's XRM service capabilities for the UE 102, the N2 message to notify NG-RAN's XRM service capabilities may be a new N2 UE-associated message. In yet another example, if there is a change of serving NG-RAN, the N2 message to notify NG-RAN's XRM service capabilities may be a Patch Switch Request message. In response to the received N2 message, the AMF 162 sends an N2 response 426. If the serving NG-RAN did not change, the N2 message is a UE Context Modification message. If the serving NG-RAN did change, the N2 message is a Path Switch response message. Note that given the various situations covered, step 329 is optional.

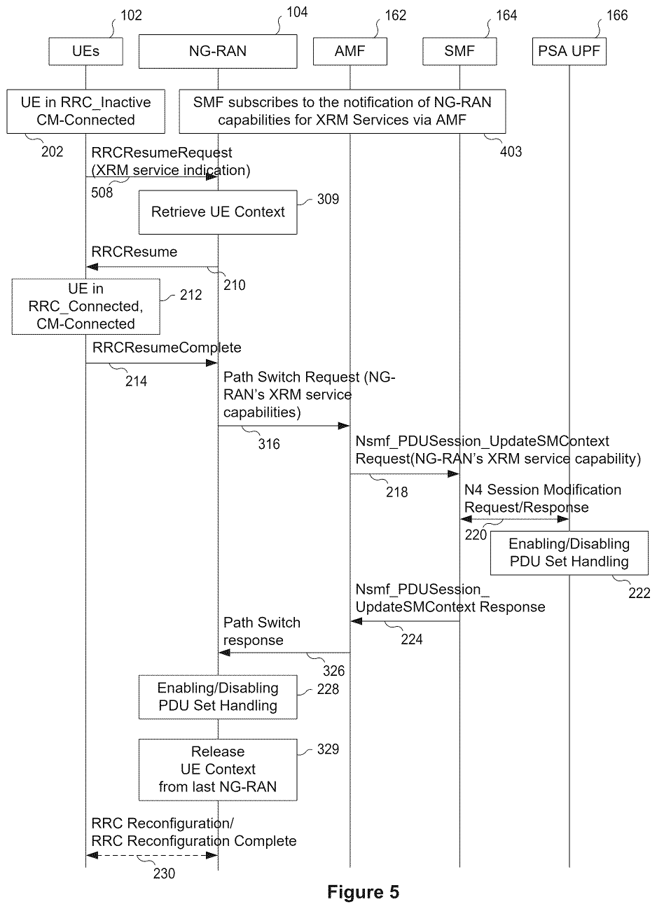

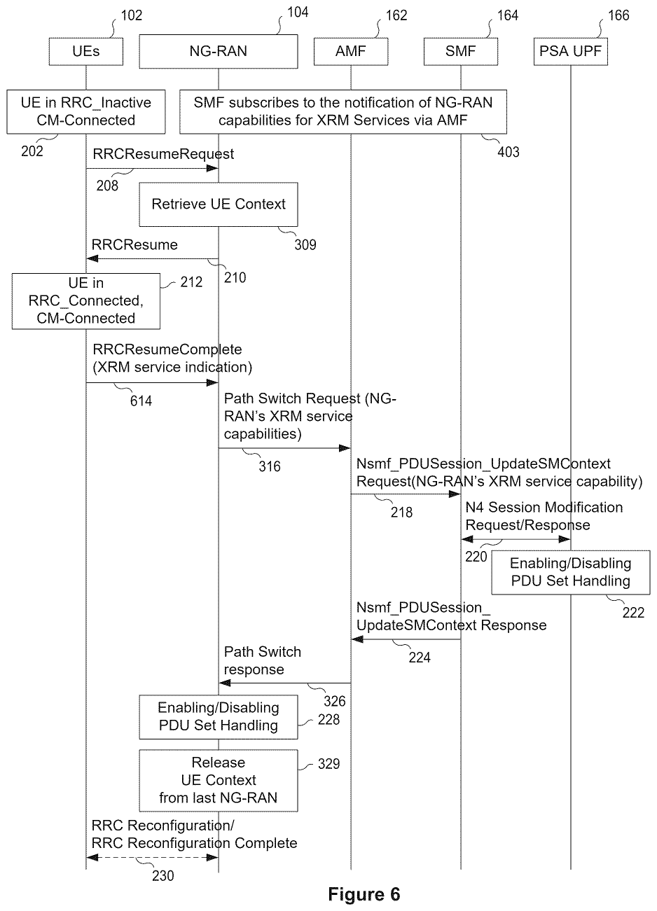

Following the scenario illustrated in FIG. 4, the connection resume procedure may further include the following descriptions which are related to the scenarios shown in FIGS. 5 and 6. Based on the stored UE context, including PDU Sessions and PDU Set QoS parameters for PDU Set based Handling for XRM Services, the UE 102 provides an XRM service indication to the NG-RAN 104. Receiving this XRM service indication triggers the NG-RAN 104 to report its NG-RAN's XRM service capabilities to the AMF 162. The UE 102 provides an XRM service indication using: (1) an RRCResume message or (2) an RRCResumeComplete message.

FIG. 5 is a signal diagram illustrating a scenario in which a UE provides an XRM service indication in an RRCResumeRequest message to its currently-serving NG-RAN node according to an embodiment. Because this scenario is similar to the previously-described scenarios, only the particular aspects are now discussed. The UE 102, which is initially 202 in an RRC_Inactive and CM-Connected state, sends 508 an RRCResumeRequest message including an XRM service indication to the NG-RAN 104. This message initiates a resume connection procedure for the UE as previously described.

FIG. 6 is a signal diagram illustrating a scenario similar to the scenario illustrated in FIG. 5, but here the UE 102 provides an XRM service indication in an RRCResumeComplete message according to an embodiment.

In FIG. 6, the UE 102 sends 614 the XRM service indication embedded in an RRCResumeComplete message at the end of the connection resume procedure.

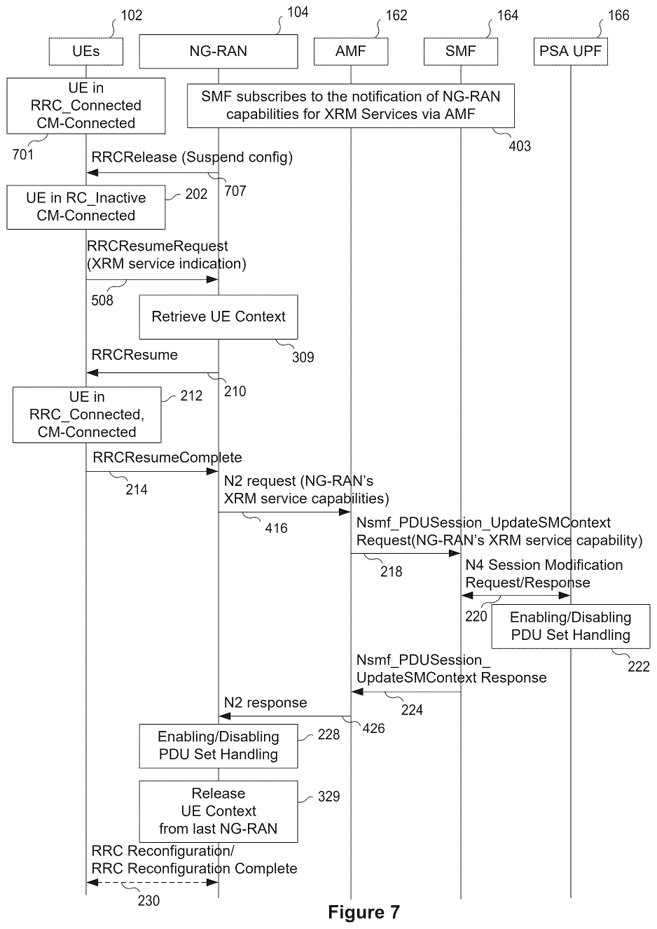

In some embodiments, the connection resume procedure may be further modified. For example, when the NG-RAN UE context includes PDU session information and PDU set QoS parameters for PDU Set based handling for XRM services, in an embodiment the NG-RAN 104 sends an RRCRelease message including a suspend config that indicates the NG-RAN's XRM services capabilities (e.g., which can be set as “supported” or “not supported”). The UE 102 uses this information to provide an XRM service indication during a resume connection procedure as described in FIGS. 5 and 6. For example, FIG. 7 is a signal diagram illustrating a scenario similar to the scenario illustrated in FIG. 5, but in which the UE 102 provides 508 its XRM service indication in an RRCResumeRequest message based on a suspend configuration received 707 from its last-serving NG-RAN node before the UE became inactive according to an embodiment.

In more detail, the UE 102, which is initially 701 in an RRC_Connected and CM-Connected state receives 707 an RRCRelease message including UE's suspend configuration from the NG-RAN node 104 serving the UE 102 at that time. The UE's suspend configuration is based on NG-RAN UE Context and indicates the NG-RAN's XRM service capabilities. The UE 102, which is 202 in an RRC_Inactive and CM-Connected state, then sends 508 an RRCResumeRequest message including XRM service indication to the NG-RAN 104.

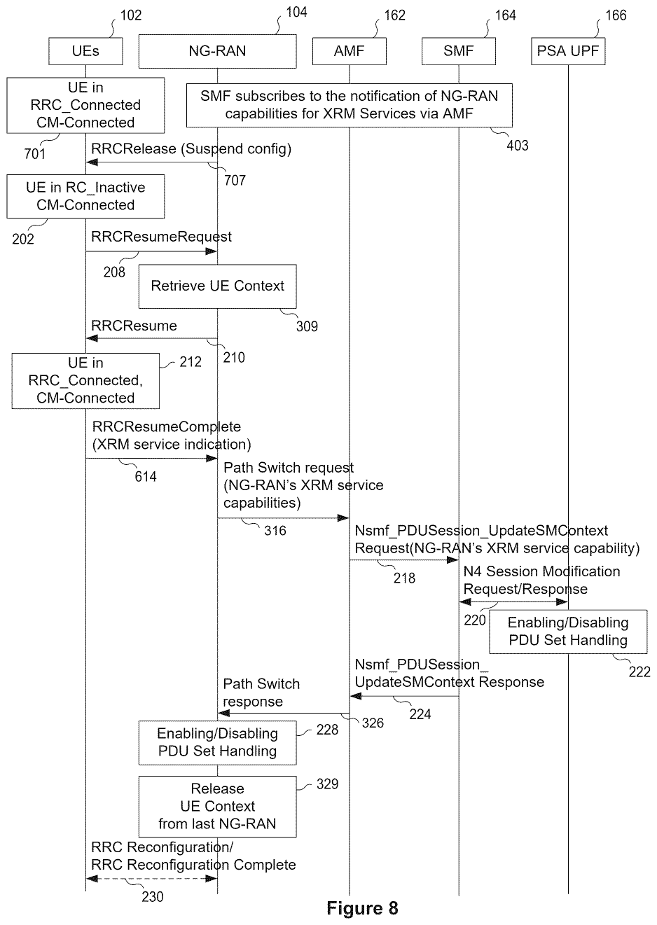

FIG. 8 is a signal diagram illustrating a scenario combining aspects of the scenarios illustrated in FIGS. 6 and 7 according to an embodiment. In FIG. 8, the UE 102 sends 614, to the NG-RAN 104, an RRCResumeComplete message including the XRM service indication, which is based on the previously received 707 suspend configuration.

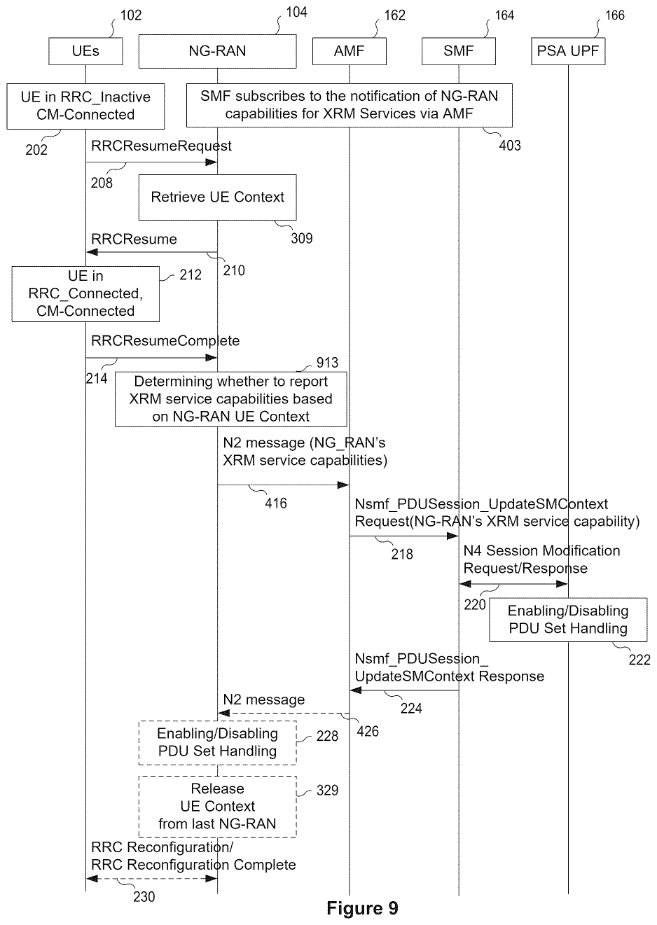

Thus, FIG. 9 is a signal diagram illustrating a scenario similar to the scenario illustrated in FIG. 4, but in which a currently serving NG-RAN node determines whether to signal its XRM service capability to the AMF according to an embodiment.

The connection resume procedure, which includes the NG-RAN signaling its XRM service capability in view of AMF/SMF event report subscription (e.g., illustrated in FIG. 4), is modified as follows. In the scenario in FIG. 9, the NG-RAN node determines 913 whether to signal its XRM service capability based on the NG-RAN UE context. The execution of steps following 913, the content and/or type of N2 messages exchanged after 913 varies depending upon different conditions as now discussed. The NG-RAN 104 may decide at 913 not to notify the AMF 162 about its XRM's service capabilities when there is no change of serving NG-RAN while the UE is inactive, and if the AMF 162 does not request the RRC inactive state transition notification. In this case, the steps following 913 are not performed.

When the NG-RAN UE context contains a PDU Session Resource Setup List that has at least one PDU Session with PDU Set based QoS Flow with PDU Set QOS Parameters, thus requiring NG-RAN's XRM service capabilities for PDU Set based Handling, the serving NG-RAN sends N2 message including an NG-RAN's XRM service capabilities for PDU Set based Handling to the AMF 162. The content of this N2 Message depends on (i) whether the serving RAN changed while the UE was inactive, (ii) whether the SMF has requested an RRC inactive state transition notification, and (iii) whether the serving NG-RAN needs to change its support of NG-RAN's XRM service capabilities for the UE. If there is no change in serving NG-RAN but the serving NG-RAN changes its support of the NG-RAN's XRM service capabilities for the UE was signaled in N2 message 416, then the AMF 162 might: (1) not send N2 message 426 which means steps 228, 329 and 230 are also not performed thereby maintaining the current UE context in the AMF/SMF for the same PDU Set based handling for the XRM traffic; (2) send N2 message 426, which is an N2 UE-associated response message in response to N2 message 416; or (3) send the N2 message 426 which is a UE Context Modification message to indicate the change of UE Context for the downlink CN tunnel information associated with steps/action/messages 218, 220, 222 and 224. If there is a change of the serving NG-RAN, then the N2 message 426 might be a Path Switch response.

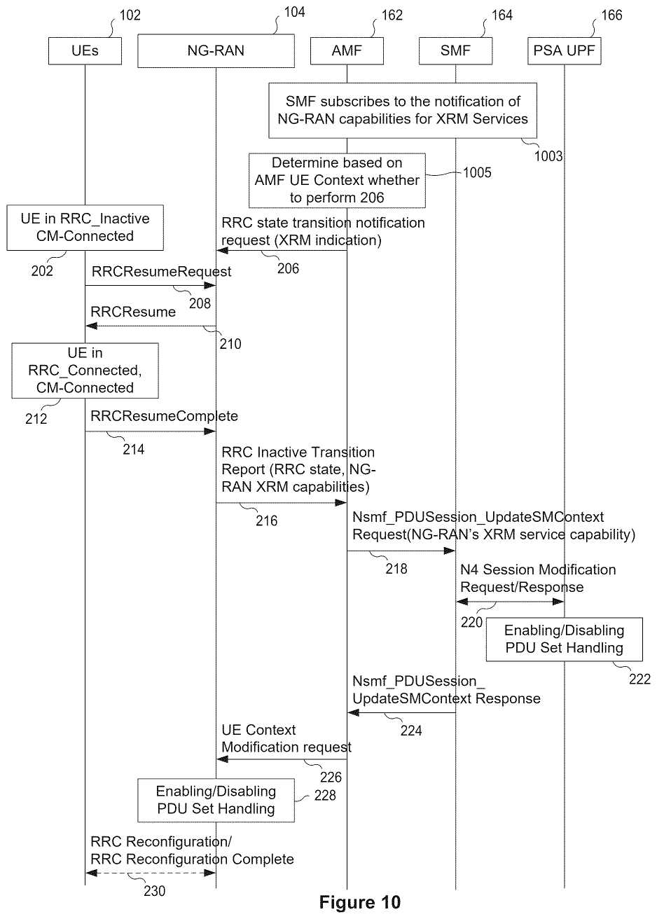

In an embodiment, in FIG. 10, the connection resume procedure may further include the following addition(s). If the AMF UE context contains SM contexts that have at least one PDU Session with XRM service indication for PDU Set based handling, the AMF 162 transmits 206 an RRC_inactive state transition report request message including NG-RAN's XRM service capabilities report indication from the NG-RAN 104. The NG-RAN 104 stores the RRC inactive state report request and NG-RAN's XRM service capabilities report indication in NG-RAN UE Context. With the NG-RAN's XRM service capabilities report indication, the NG-RAN reports 216 NG-RAN's XRM service capabilities if the RRC state is changed to RRC_Connected state. Based on NG-RAN UE Context with RRC inactive state report request 206 and NG-RAN's XRM service capabilities report indication 216, if there is no change of the Serving NG-RAN, the Serving NG-RAN sends an N2 message including RRC state to notify the AMF that the UE state changed from RRC_inactive state to RRC_connected state. If there is a change of the Serving NG-RAN, the Serving NG-RAN retrieves NG_RAN UE Context and performs a path switch procedure per FIG. 3. If there is no change of NG-RAN's XRM service capabilities, the serving NG-RAN 104 sends a Path Switch message including RRC state to the AMF 162. If there is a change of NG-RAN's XRM service capabilities, the serving NG-RAN 104 sends a Path Switch message including RRC state and NG-RAN's XRM service capabilities to the AMF 162.

FIG. 10 is signal diagram illustrating a scenario in which the SMF 164 subscribes for NG-RAN XRM service capability notification and the AMF 162 requests RRC state transition notification based on the AMF UE context according to an embodiment. In this scenario, the SMF 164 subscribes 1003 (e.g., sends a subscription request) to the AMF 162 for notification of NG-RAN XRM service capabilities for PDU Set based handling according to PDU Set QoS parameters. In view of the AMF UE context, the AMF 162 determines 1005 whether to request the NG-RAN for UE's RRC state transition notification. That is, if the UE were not authorized during the registration process for XRM services, the AMF would not request the NG-RAN for UE's RRC state transition notification. Assuming now that the result of the determination is positive, the AMF 162 sends 206, to the NG-RAN 104, an RRC state transition notification request that includes an XRM indication.

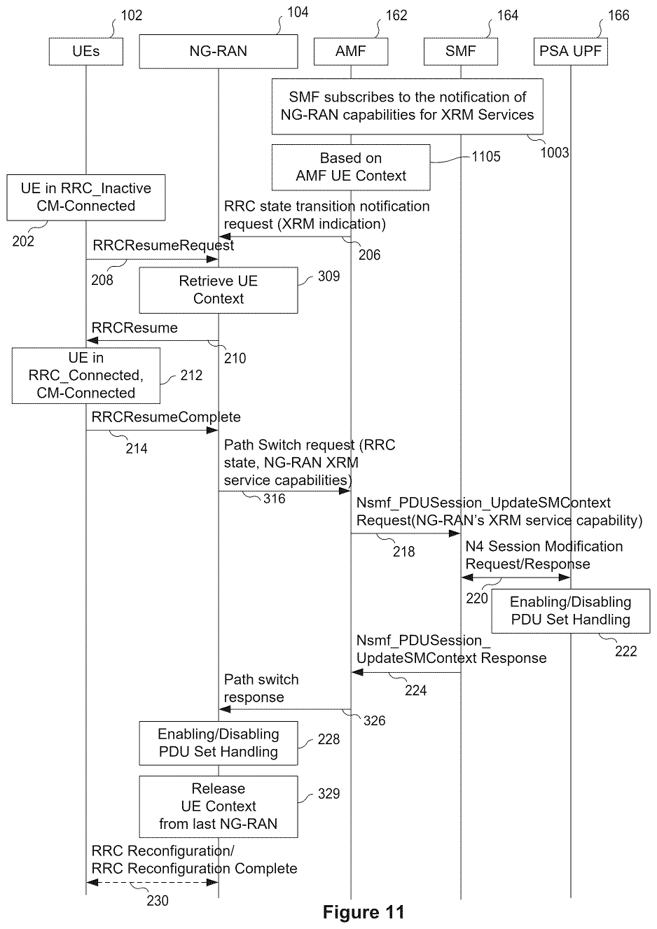

FIG. 11 is a signal diagram illustrating a scenario similar to the scenario illustrated in FIG. 10, but with a change of the serving NG-RAN 104 while the UE 102 is in an RRC_Inactive state according to an embodiment. That is, if the service NG-RAN 104 is not changed in FIG. 10, the path switch message is not needed, and the serving NG-RAN notifies the AMF 162 via message 216 in response to the request message 206. This scenario includes steps 1003 and 1005 described relative to FIG. 10, but steps 216 and 226 are replaced by 316 and 326 when the serving NG-RAN 104 changed while the UE 102 was inactive.

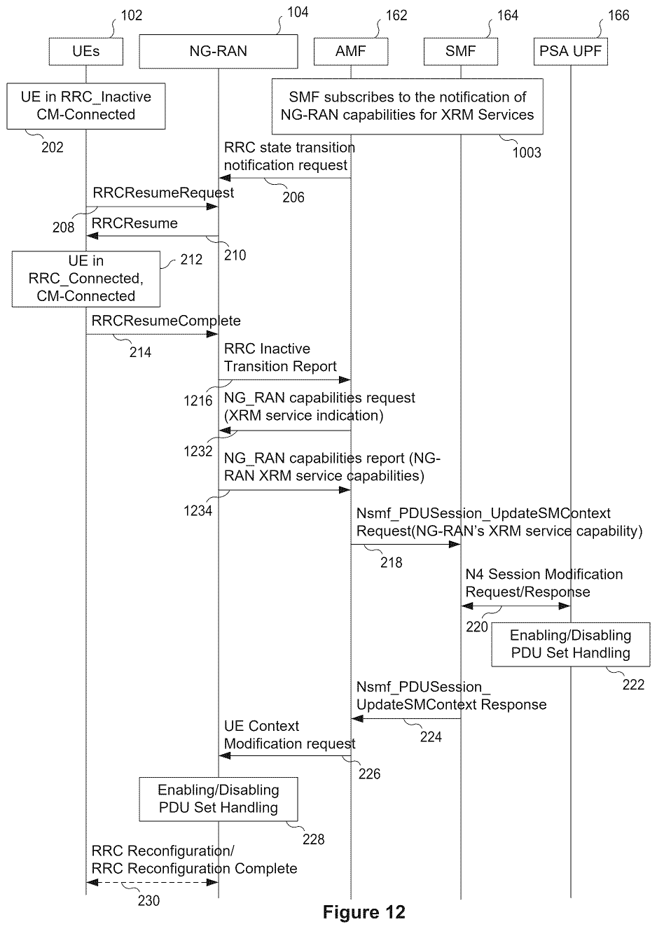

FIG. 12 is a signal diagram illustrating a scenario in which the AMF 162 and/or an SMF 164 requests the NG-RAN's XRM service capabilities upon receiving an RRC state transition notification according to an embodiment. The RRC state transition does not indicate what info to send to SMF and, therefore, another request message is needed to retrieve a specific info. In this scenario, the NG-RAN 104 transmits 1216 an RRC Inactive Transition Report message to the AMF 162 after receiving 214 an RRCResumeComplete message. The AMF 162 responds 1232 to the NG-RAN 104, with an NG-RAN capabilities request including an XRM service indication. With the indication, the NG-RAN 104 then 1234 sends an NG-RAN XRM service capabilities report to the AMF 162. The message 1234 may be an N2 message when the RRC state of the UE 102 changes to RRC_Connected.

In some embodiments, a UE's RRCResumeRequest message in any of the scenarios illustrated in FIGS. 2-12 includes a resume cause indicating an RNA update. The NG-RAN 104 then may perform the following: (1) allow the UE 104 to remain in an RRC_Inactive state or to return to an RRC_Connected state after the serving NG-RAN receives 208 the RRCResumeRequest and obtains NG-RAN's UE Context (stored in current NG-RAN or retrieved from the last NG-RAN); or (2) if the UE 102 is entering an RRC_Connected state, the NG-RAN sends 416 an N2 message that includes the NG-RAN's XRM service capabilities for PDU Set based Handling to the AMF 162.

For example, if there is no change of NG-RAN 104 and the AMF 162 does not request an RRC Inactive state transition notification, the NG-RAN 104 resumes the RRC connection without notifying AMF 162. In another example, if there is no change of NG-RAN 104 and the serving NG-RAN needs to change its support of NG-RAN's XRM service capabilities for the UE 102, the N2 message to notify NG-RAN's XRM service capabilities can be a new N2 UE-associated message. In yet another example, if there is a change of the serving NG-RAN and NG-RAN UE context contains PDU sessions with PDU Set based QoS flows, the N2 message to notify NG-RAN's XRM service capabilities for PDU Set based handling is a Path Switch Request message.

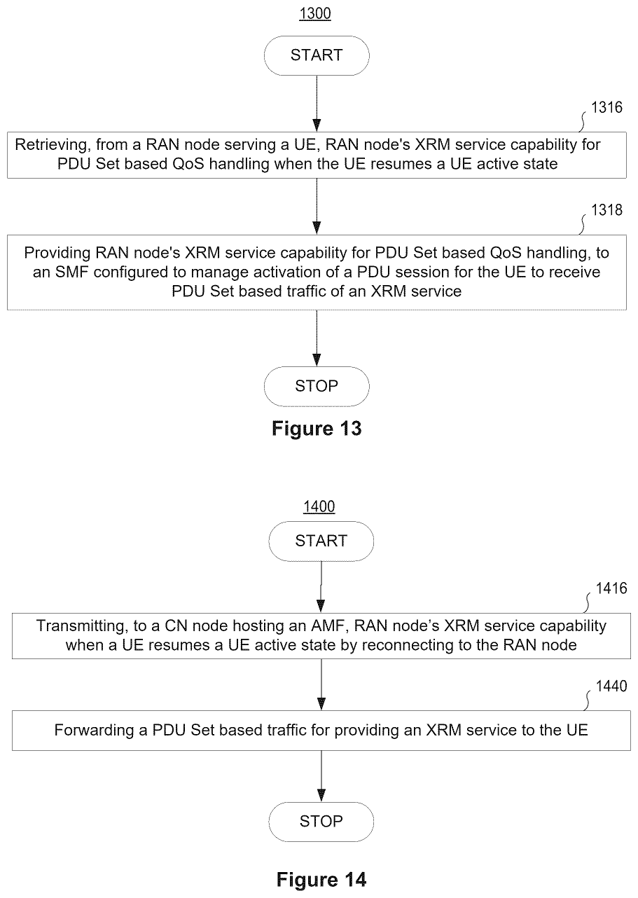

FIGS. 13-15 are flowcharts of methods performed by a CN node, an RAN node, and a UE all for when a UE resumes an RRC connection and has a PDU session for an XRM service that requires the RAN node to perform PDU set based handling.

These methods correspond to scenarios illustrated in FIGS. 2-12.

FIG. 13 is a flowchart of a method 1300 performed by a core network, CN, node 150, hosting an AMF. The method 1300 includes retrieving 1316, from a RAN node (e.g., 104) serving a UE (e.g., 102), RAN node's XRM service capability for PDU Set based QoS handling when the UE resumes an RRC_connected state. Examples of this retrieving 1316 are shown in the signal flow diagrams as 216, 316, 416, and 1234. The method 1300 further includes providing 1318 the RAN node's XRM service capability for PDU Set based QoS handling to an SMF configured to manage activation of a PDU session for the UE to receive PDU Set based QoS traffic for an XRM service. Examples of this providing 1318 are shown in the signal flow diagrams as 218.

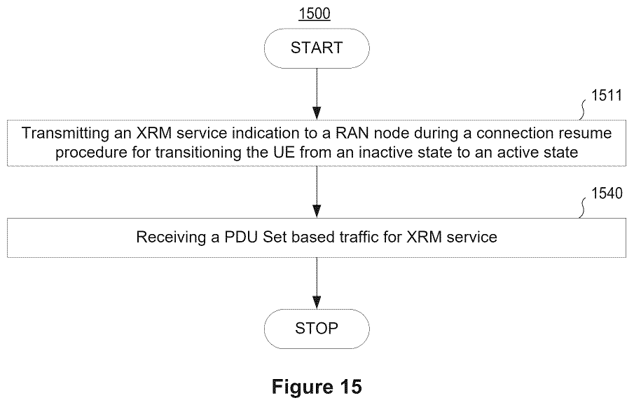

FIG. 14 is a flowchart of a method 1400 performed by a RAN node (e.g., 104). The method 1400 includes transmitting 1416, to a CN node (e.g., 150) hosting an AMF, RAN node's XRM service capability for PDU Set based QoS handling when a UE (e.g., 102) resumes an RRC_connected state. Examples of this transmitting 1416 are shown in the signal flow diagrams as 216, 316, 416, and 1234. The method 1400 further includes performing PDU Set based QoS handling for PDU Set based QoS traffic and forwarding 1440 a PDU Set based QoS traffic for providing an XRM service to the UE.

Examples of this forwarding 1440 are shown in the signal flow diagrams as 240.

FIG. 15 is a flowchart of a method 1500 performed by a UE (e.g., 102) in a RAN (e.g., 105). The method 1500 includes transmitting 1511 an XRM service indication to a RAN node (e.g., 104) of the RAN, during a connection resume procedure for transitioning the UE from an RRC_inactive state to an RRC_connected state.

Examples of this transmitting 1511 are shown in the signal flow diagrams as 508 and 614. The method 1500 further includes receiving 1540 a PDU Set based QoS traffic for the XRM service. Examples of this receiving 1540 are shown in the signal flow diagrams as 240.

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Numerical adjectives “first”, “second”, and “third” do not imply any order (are not ordinals) but are markers to distinguish separate instances of similar elements.

References to the singular (e.g., “a” or “an”, “the”) should include the plural unless clearly indicated otherwise.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-17. (canceled)

18. A wireless communication method performed by a core network node hosting an Access and Mobility Management Function, the method comprising:
receiving, from a radio access network (RAN) node serving a user equipment (UE), an extended reality and media (XRM) service capability for Packet Data Unit (PDU) Set based Quality of Service (QOS) handling of the RAN node when the UE resumes a connected state; and
providing the XRM service capability for PDU Set based QOS handling of the RAN node to a Session Management Function (SMF) configured to manage activation of a PDU session for the UE to receive PDU Set based traffic for an XRM service.

19. The wireless communication method of claim 18, further comprising:
sending, to the RAN node, core network assistance information including at least one of:
a UE's capability to receive XRM services,
an indication as to whether a currently-active PDU session provides PDU Set based QoS traffic of the XRM service,
a preference to avoid an inactive state due to the currently-active PDU session, or
a discontinuous reception configuration provided to the UE for the currently-active PDU session.

20. The wireless communication method of claim 19, wherein the core network assistance information is based on at least one of:
a UE context indicating whether the UE is authorized to receive the XRM service and PDU session information of the PDU session, or
a UE subscription for receiving XRM service based on the XRM service capability of the RAN node.

21. The wireless communication method of claim 18, wherein the
receiving of the XRM service capability for PDU Set based QoS handling of the RAN node includes:
sending, to the RAN node, a notification request; and
receiving, from the RAN node a notification including the XRM service capability when the UE resumes the connected state.

22. The wireless communication method of claim 21, wherein p1 the notification request is a forwarded SMF notification subscription request and the notification is an inactive transition report, or
the notification request is a state transition notification request for the XRM service capability, and the notification is an inactive transition report or a path switch request message depending on whether the RAN node was UE's serving node before the UE entered an inactive state.

23. The wireless communication method of claim 21, further comprising:
sending, to the RAN node, core network assistance information including at least one of:
a UE's capability to receive XRM services,
an indication as to whether a currently-active PDU session provides PDU Set based QoS traffic of the XRM service,
a preference to avoid an inactive state due to the currently-active PDU session, or
a discontinuous reception configuration provided to the UE for the currently-active PDU session.

24. The wireless communication method of claim 18, wherein the receiving includes requesting the XRM service capability upon receiving a path switch message.

25. The wireless communication method of claim 24, further comprising:
sending, to the RAN node, core network assistance information including at least one of:
a UE's capability to receive XRM services,
an indication as to whether a currently-active PDU session provides PDU Set based QoS traffic of the XRM service,
a preference to avoid an inactive state due to the currently-active PDU session, or
a discontinuous reception configuration provided to the UE for the currently-active PDU session.

26. A core network device in a wireless communication system, the device comprising:
a transceiver enabling the core network device to exchange messages wirelessly with other devices in the wireless communication system; and
a processor connected to the transceiver and hosting an Access and Mobility Management Function and configured to perform, using the transceiver:
receiving, from a radio access network (RAN) node serving a user equipment (UE), an extended reality and media (XRM) service capability for Packet Data Unit (PDU) Set based Quality of Service (QOS) handling of the RAN node when the UE resumes a connected state; and
providing the XRM service capability for PDU Set based QoS handling of the RAN node to a Session Management Function (SMF) configured to manage activation of a PDU session for the UE to receive PDU Set based traffic for an XRM service.

27. The core network device of claim 26, wherein the processor is further configured to perform using the transceiver:
sending, to the RAN node, core network assistance information including at least one of:
a UE's capability to receive XRM services,
an indication as to whether a currently-active PDU session provides PDU Set based QoS traffic of the XRM service,
a preference to avoid an inactive state due to the currently-active PDU session, or
a discontinuous reception configuration provided to the UE for the currently-active PDU session.

28. A wireless communication method performed by a radio access network (RAN) node, the method comprising:
transmitting, to a core network node hosting an Access and Mobility Management Function, an extended reality and media (XRM) service capability for Packet Data Unit (PDU) Set based quality of service (QOS) handling of the RAN node when a user equipment (UE) resumes a connected state; and
forwarding a PDU Set based QoS traffic for providing an XRM service to the UE.

29. The wireless communication method of claim 28, further comprising:
receiving core network assistance information; and
using the core network assistance information in preparing a connection release message transmitted to the UE.

30. The wireless communication method of claim 29, wherein the core network assistance information includes at least one of:
a UE's capability to receive XRM services,
an indication as to whether a currently-active PDU session provides the PDU Set based QoS traffic of the XRM service,
a preference to avoid an inactive state during to the currently-active PDU session, or
a discontinuous reception configuration provided to the UE for the currently-active PDU session.

31. The wireless communication method of claim 28, further comprising:
receiving, from the core network node, an event notification request, wherein the transmitting of the XRM service capability is triggered by detecting the event.

32. The wireless communication method of claim 28, wherein the transmitting of the XRM service capability for PDU Set based QoS handling of the RAN node is based on a RAN UE context.

33. A radio access network (RAN) node in a wireless communication system, the node comprising:
a transceiver enabling the RAN node to exchange messages wirelessly with other devices in the wireless communication system; and
a processor connected to the transceiver and configured to perform, using the transceiver:
transmitting, to a core network node hosting an Access and Mobility Management Function, an extended reality and media (XRM) service capability for Packet Data Unit (PDU) Set based quality of service (QOS) handling of the RAN node when a user equipment (UE) resumes a connected state; and
forwarding a PDU Set based QoS traffic for providing an XRM service to the UE.

34. The RAN of claim 33, wherein the processor is further configured to perform, using the transceiver:
receiving core network assistance information; and
using the core network assistance information in preparing a connection release message transmitted to the UE,
wherein the core network assistance information includes at least one of:
a UE's capability to receive XRM services,
an indication as to whether a currently-active PDU session provides the PDU Set based QoS traffic of the XRM service,
a preference to avoid an inactive state during to the currently-active PDU session, or
a discontinuous reception configuration provided to the UE for the currently-active PDU session.

35. A wireless communication method performed by a user equipment (UE) in a radio access network, the method comprising:
transmitting an extended reality and media, XRM, service indication to a radio access network node during a connection resume procedure for transitioning the UE from an inactive state to a connected state; and
receiving a Packet Data Unit (PDU) Set based quality of service (QOS) traffic for the XRM service.

36. The wireless communication method of claim 35, wherein the transmitting includes:
transmitting the XRM service indication with a radio resource control (RRC) resume request message initiating the connection resume procedure, or
transmitting the XRM service indication with an RRC resume complete message concluding the connection resume procedure.

37. The wireless communication method of claim 36, wherein
the transmitting of the XRM service indication is triggered when the RAN node is different from a pre-inactive state RAN node serving the UE before the UE entered the inactive state, and/or
the transmitting of the XRM service indication is based on a UE context or a suspend configuration received by the UE prior to entering the inactive state.
